(19) United States
(12) Patent Application Publication
(10) Pub. No.: US 2026/0211925 A1
(43) Pub. Date: Jul. 23, 2026

(54) REFINEMENT OF CONTEXT DATA FOR IMPROVED RESPONSE GENERATION

(71) Applicant: Dell Products L.P., Round Rock, TX (US)

(72) Inventors: OFIR EZRIELEV, Be'er Sheva (IL); LEV MAKLER, Be'er Sheva (IL); YEHONATAN COHEN, Ashdod (IL)

(21) Appl. No.: 19/034,973

(22) Filed: Jan. 23, 2025

(51) Int. Cl. G06F 16/335; G06F 16/338

(52) U.S. Cl. CPC G06F 16/335; G06F 16/338

(57) ABSTRACT

Methods and systems for managing operation of a deployment are disclosed. The operation may be managed by refining a quality of context data used to generate a response to address a prompt concerning the operation of the deployment. The context data may include duplicative context data and/or conflicting context data. In an information elimination process, the duplicative context data and/or the conflicting context data may be removed from the context data and a new rank ordering of the context data may be established to generate refined context data. The refined context data may be ingested by a trained generative machine-learning model to generate the response. The response may be used to improve a provisioning of computer implemented services by the deployment.

### FIELD

Embodiments disclosed herein relate generally to managing operation of a deployment. More particularly, embodiments disclosed herein relate to refining a quality of context data used to generate a response to address a prompt concerning the operation of the deployment.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a diagram illustrating a system in accordance with an embodiment.

FIGS. 2A-2C show data flow diagrams illustrating operation of a system in accordance with an embodiment.

FIG. 3 shows a flow diagram illustrating at least one method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to managing operation of a deployment. The operation may be managed by refining a quality of context data used to generate a response to address a prompt concerning the operation of the deployment. The prompt may include at least one description regarding operation of a deployment. The at least one description may describe a behavior of the operation that impacts a provision of computer implemented services by the deployment.

The context data may be retrieved from a trusted knowledge base of the deployment. However, the context data may include duplicative context data and/or conflicting context data. Upon ingestion of the context data by a trained generative machine-learning model to generate a response to the behavior, the duplicative context data and/or the conflicting context data may impact a second quality of the response.

Therefore, an information elimination process may be performed to refine the quality of the context data. The information elimination process may include removal of the duplicative context data and/or the conflicting context data as well as a new rank ordering of the context data to generate refined context data.

The refined context data may then be ingested by the trained generative machine-learning model to generate the response to the behavior. The response may be used to improve the provision of the computer implemented services.

In an embodiment, a method for managing operation of a deployment is disclosed. The method may include: (i) obtaining, based on a prompt for processing by a trained generative machine-learning model, a set of chunks and rank ordering for the set of the chunks from a knowledge data source, (ii) performing an information elimination on the set of the chunks to obtain: (a) a portion of the set of chunks, (b) a set of pseudo chunks based on a second portion of the set of the chunks, and (c) a second rank ordering that defines ordering among the portion of the set of the chunks and the set of the pseudo chunks, (iii) obtaining, using at least the portion of the set of the chunks, the set of the pseudo chunks, the second rank ordering, and a trained generative machine-learning model, a response to the prompt, and (iv) providing computer implemented services using the response.

Portions of each of the second portion of the set of chunks, during the information elimination process, may be removed to obtain the set of pseudo chunks.

The portions of each of the second portion of the set of chunks may include duplicative of contradictory information with respect to at least one of the portion of the set of chunks.

The second rank ordering may be obtained using a same process through which the rank ordering is obtained, and the second rank ordering may take into account the removed portions of each of the second portion of the set of chunks.

Elimination of the portions of each of the second portion of the set of chunks may change relevancies of the second portion of the set of chunks with respect to the prompt.

The rank ordering and the second rank ordering may indicate relevancy with respect to the prompt.

The prompt may be based on a behavior of a data processing system, and the response may indicate at least one selected from a group consisting of: (a) a root cause for the behavior, (b) a remediation process to be performed to address the behavior, and (c) a diagnosis process for the behavior.

The knowledge data source may include a plurality of chunks, and the set of chunks is a sub-set of the plurality of chunks that are evaluated as being relevant to the prompt.

At least two of the plurality of chunks may include contradictory information regarding a portion of the prompt.

At least two of the plurality of chunks may include duplicative information regarding a portion of the prompt.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

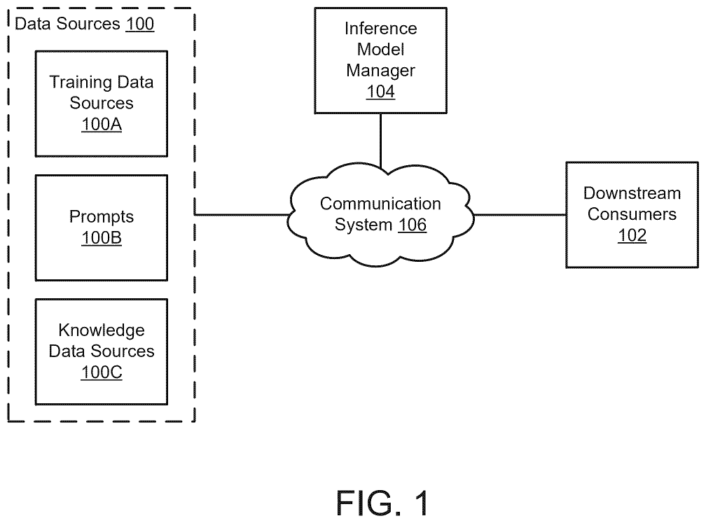

Turning to FIG. 1, a system in accordance with an embodiment is shown. The system may provide any number and types of computer implemented services (e.g., to user of the system and/or devices operably connected to the system). The computer implemented services may include, for example, data storage service, instant messaging services, etc.

To provide the computer implemented services, context data may be retrieved from a trusted knowledge base. The context data may be retrieved by performing a retrieval augmented generation process. The retrieval augmented generation process may include (i) performing, by a retrieval augmented system, a search in a database of stored context data, (ii) identifying at least one data chunk of context data, (iii) ranking the at least one data chunk based on any magnitude of relevancy of the at least one data chunk to a prompt, on which the search is based, to generate at least one ranked data chunk, and/or (iv) providing the at least one ranked data chunk to a trained generative machine-learning model (e.g., large language models, small language models, retrieval augmented generators, etc.) to generate a response of the prompt.

The context data may include (i) system logs (e.g., at least one record of an event and/or an activity within a data processing system, etc.), (ii) performance metrics (e.g., memory consumption, at least one input/output operation, network traffic, etc.), (iii) system health checks (e.g., at least one report of a status of the data processing system, etc.), etc. The prompt may include at least one description regarding operation of the data processing system of a deployment. The at least one description may describe a behavior of the operation that impacts a provision of computer implemented services by the data processing system of the deployment. The at least one data chunk may include a discrete and/or segmented portion of the context data (e.g., a key and/or value pair from a system log and/or a report of the performance metrics, a status message from a system health check, etc.).

However, the context data may include duplicative context data and/or conflicting context data. Therefore, upon ingestion of the context data by the trained generative machine-learning model, the trained generative machine-learning model may generate a response that does not accurately and/or efficiently indicate (i) a root cause of the behavior, (ii) a remediation process to address the behavior, (iii) a diagnosis process for the behavior, etc. As a result, a provision of computer implemented services by the data processing system may be impacted.

In general, embodiments disclosed here relate to systems and methods for managing operation of a deployment. The operation may be managed by (i) obtaining, based on a prompt for processing by a trained generative machine-learning model, a set of chunks (e.g., at least one data chunk, etc.) and rank ordering for the set of chunks from a knowledge data source, (ii) performing an information elimination on the set of chunks to obtain: (a) a portion of the set of chunks, (b) a set of pseudo chunks based on a second portion of the set of chunks, and (c) a second rank ordering that defines ordering among the portion of the set of chunks and the set of pseudo chunks, (iii) obtaining, using at least the portion of the set of chunks, the set of pseudo chunks, the second rank ordering, and the trained generative machine-learning model, a response to the prompt; and (iv) providing the computer implemented services using the response.

The set of chunks and the rank ordering for the set of the chunks may be obtained by performing a retrieval augmented generation process. The retrieval augmented generation process may include (i) performing, by a retrieval augmented system, a search in a database of stored context data, (ii) identifying at least one data chunk of context data, (iii) ranking the at least one data chunk based on any magnitude of relevancy of the at least one data chunk to a prompt, on which the search is based, to generate at least one ranked data chunk, and/or (iv) providing the at least one ranked data chunk to a trained generative machine-learning model (e.g., large language models, small language models, retrieval augmented generators, etc.) to generate a response of the prompt. The knowledge data source may include a database, repository, etc. of at least one system log, at least one performance metric, at least one system health check, etc.

The information elimination may be performed by eliminating duplicative context data and/or conflicting context data from the set of the chunks. To eliminate the duplicative context data and/or the conflicting context data, the at least one data chunk of the set of chunks may be compared to a second at least one data chunk. If duplicative context data is found between the at least one data chunk and the second at least one data chunk, information in either the at least one data chunk and/or the second at least one data chunk may be removed to eliminate the duplicative context data.

Further, if conflicting context data is found, between the at least one data chunk and the second at least one data chunk, the information in either the at least one data chunk and/or the second at least one data chunk may be removed to eliminate the conflicting context data. The conflicting context data may be removed, for example, in a data chunk of the at least one data chunk and/or the second at least one data chunk. The conflicting context data may be removed by, for example, confirming at least one definition of ontology terms (e.g., words and/or phrases defined by an administrator, trusted knowledge base, etc. of the data processing system, etc.) and/or eliminating a portion of the at least one data chunk and/or the second at least one data chunk that utilizes the ontology terms.

The set of the pseudo chunks may be generated from the set of the chunks in which the duplicative context data and/or conflicting context data has been eliminated. Further, the set of pseudo chunks may include a third at least one data chunk that therefore may be in an edited format compared to the third at least one data chunk that includes the duplicative context data and/or the conflicting context data extracted from the trusted knowledge base. The portion of the set of chunks may include the at least one data chunk in which the duplicative context data and/or conflicting context data is not present.

With the set of the pseudo chunks and/or the portion of the set of the chunks, the second rank ordering of the set of the chunks may be generated. The second rank ordering may be generated by using (i) keyword matching, (ii) term frequency methods, (iii) natural language processing, etc. to rank the set of the pseudo chunks and the portion of the set of the chunks based on any magnitude of relevancy to the prompt.

Using the set of the pseudo chunks, the portion of the set of the chunks, and/or the second rank ordering, the information elimination may be repeated until at least one criterium is met. The at least one criterium may include (i) a minimum number of iterations of the information elimination has been performed, (ii) a threshold score has been met and/or exceeded by (a) the keyword matching, (b) the term frequency methods, (c) the natural language processing, etc. that is set by (a) an administrator, (b) an operator, etc. of the data processing system, etc.

The response to the prompt may be obtained by ingesting, by the trained generative machine-learning model, (i) the set of the pseudo chunks, (ii) the portion of the set of the chunks, and/or (iii) the second rank ordering. Upon the ingestion, the trained generative machine-learning model may generate the response that indicates, any of, (i) a root cause of the behavior, (ii) a remediation process to address the behavior, (iii) a diagnosis process for the behavior, and/or other information usable to manage operation of systems and/or processes of the computer implemented services.

The computer implemented services may be provided using the response by (i) using the root cause in the response to identify at least one issue related to the behavior in the data processing system, (ii) performing, by the data processing system, the remediation process to address the behavior of the data processing system, (iii) performing, by the data processing system, the diagnosis process to troubleshoot the behavior of the data processing system, etc. By (i) identifying the at least one issue, (ii) addressing the behavior, (iii) troubleshooting the behavior, etc., an impact to the operation of the data processing system by the behavior may be remediated.

To provide the above-mentioned functionality, the distributed system of FIG. 1 may include data sources 100, downstream consumers 102, inference model manager 104, and communication system 106. The distributed system, any components thereof, and/or any other types of devices or components not shown in FIG. 1 may perform all, or a portion of the computer-implemented services independently and/or cooperatively. Each of these components is discussed below.

Data sources 100 may include any type and/or number of data sources. Each of data sources 100 may include hardware and/or software components configured to obtain data, store data, provide data to other entities, and/or to perform any other tasks to facilitate performance of computer-implemented services. Different data sources of data sources 100 may facilitate similar and/or different computer-implemented services. For example, data sources 100 may include training data sources 100A, prompts 100B, knowledge data sources 100C, and/or other sources of data usable to facilitate operation of inference models.

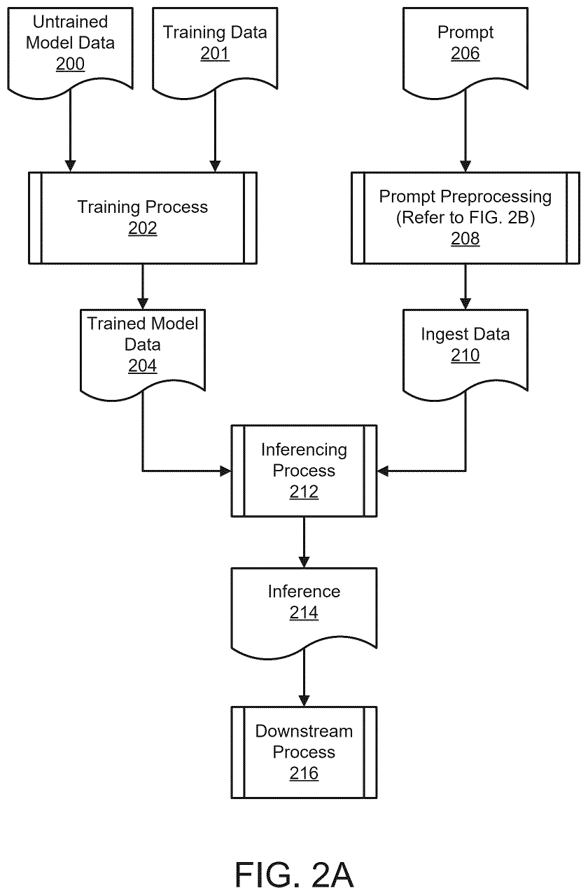

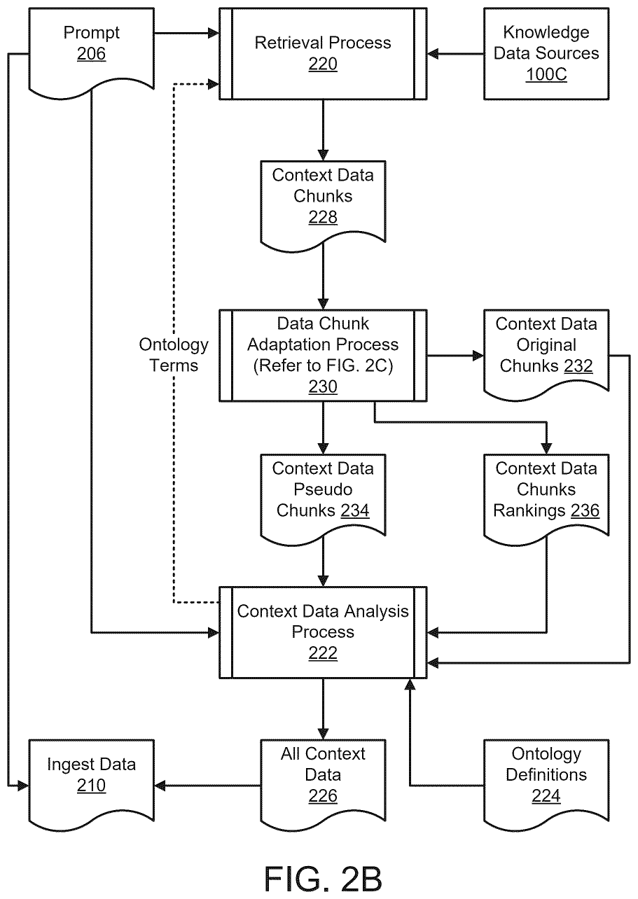

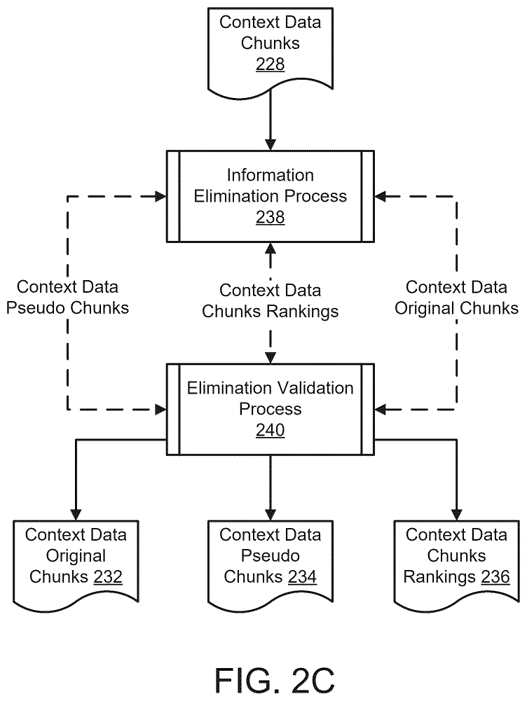

Training data sources 100A may include any number of data sources that provide training data for training of inference models. Training data sources 100A may include sources of raw data, processed data (e.g., curated data), and/or other types of data usable to train (e.g., retrain, fine-tune) the inference models. Refer to the discussion of FIG. 2A for more information regarding training of inference models.

Prompts 100B may include any volume and/or type of data for processing by the inference models. For example, prompts 100B may include any number of prompts obtained from consumers of inferences generated by the inference models (e.g., individuals, computers). Prompts 100B may include unstructured data and may be used, at least in part, to generate ingest data for inference models. For example, prompts 100B may include instances of ontology terms, and may undergo preprocessing to obtain sufficient context data for generating adequate ingest data. Refer to the discussion of FIGS. 2A-2B for more information regarding prompt preprocessing.

Knowledge data sources 100C may include any number and/or type of data sources that provide context data for prompts 100B. Knowledge data sources 100C may include a data source designated as a source of true data by an operator of inference models. Knowledge data sources 100C may be managed by the operator and/or another entity. For example, knowledge data sources 100C may include information regarding ontology terms included in ontology definitions defined by the operator and/or an organization of the operator, and may be queried during preprocessing of a prompt of prompts 100B (e.g., during a retrieval process). Refer to the discussion of FIG. 2B for more information regarding use of knowledge data sources 100C.

Data sources 100 may include data repositories (e.g., training data repositories and/or knowledge data repositories, not shown), and may provide data to (e.g., allow access to data by) inference model manager 104.

Downstream consumers 102 may include any number and/or type of downstream consumers. For example, downstream consumers 102 may include individuals, organizations, and/or computers. Downstream consumers 102 may consume all, or a portion of the computer-implemented services. For example, downstream consumers 102 may include users of the managed data processing systems.

Downstream consumers 102 may consume all, or a portion of the inferences and/or output from downstream processes that use the inferences. For example, downstream consumers 102 may generate and/or provide prompts of prompts 100B (e.g., portions of ingest data) for processing by the inference models, and may consume inferences generated by the inference models (e.g., in response to the ingest data) and/or output from the downstream processes that use the inferences. The inferences and/or output from the downstream processes may be used by downstream consumers 102 to improve decision-making and/or to automate tasks. For example, downstream consumers 102 may make decisions and/or initiate actions for managing operation of the data processing systems.

Inference model manager 104 may include any number of data processing systems and may manage any number of inference models. Inference model manager 104 may perform tasks relating to management of and/or facilitation of use of the inference models. For example, inference model manager 104 may manage (e.g., facilitate) (i) training processes for the inference models, (ii) preprocessing of prompts for the inference models, (iii) inferencing processes using the inference models (e.g., and the preprocessed prompts), (iv) downstream processes that use inferences obtained using the inference models, and/or (v) distribution of the inferences and/or output derived from the inferences to downstream consumers 102. Refer to the discussion of FIG. 2A for more details regarding operation of inference models.

To increase a likelihood of providing adequate ingest data to the inference models, inference model manager 104 may (i) obtain a prompt for an inference model (e.g., from prompts 100B), (ii) perform a first retrieval process for the prompt to obtain context data, (iii) analyze the context data based on ontology definitions to identify instances of ontology terms present in the prompt for which the context data does not meet sufficiency criteria, (iv) perform additional retrieval processes for the identified instances of ontology terms to obtain additional context data that meets the sufficiency criteria, and/or (v) obtain ingest data based on the prompt and/or the context data obtained during any of the performed retrieval processes. Refer to the discussion of FIG. 2B for an example of an ontology-based iterative retrieval process.

To facilitate management of operation of the data processing systems using inference models, inference model manager 104 may (i) use the ingest data to obtain a response (e.g., an inference) from an inference model, and/or (ii) use the response to provision desired computer-implemented services (e.g., distribute the response to downstream consumers 102 and/or by provide the response to downstream processes).

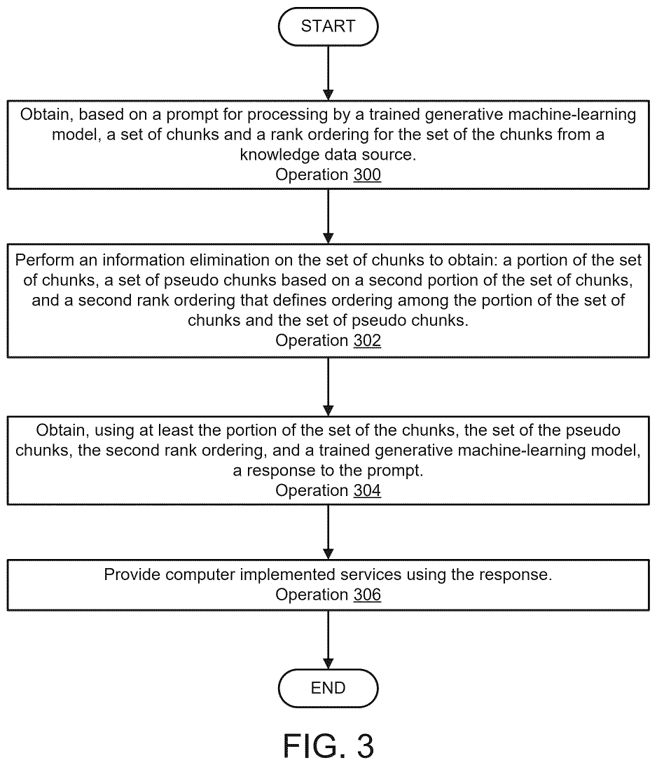

When providing their functionality, any of data sources 100, downstream consumers 102, inference model manager 104, and/or components thereof may perform all, or a portion of the actions and methods illustrated in FIGS. 2A-3.

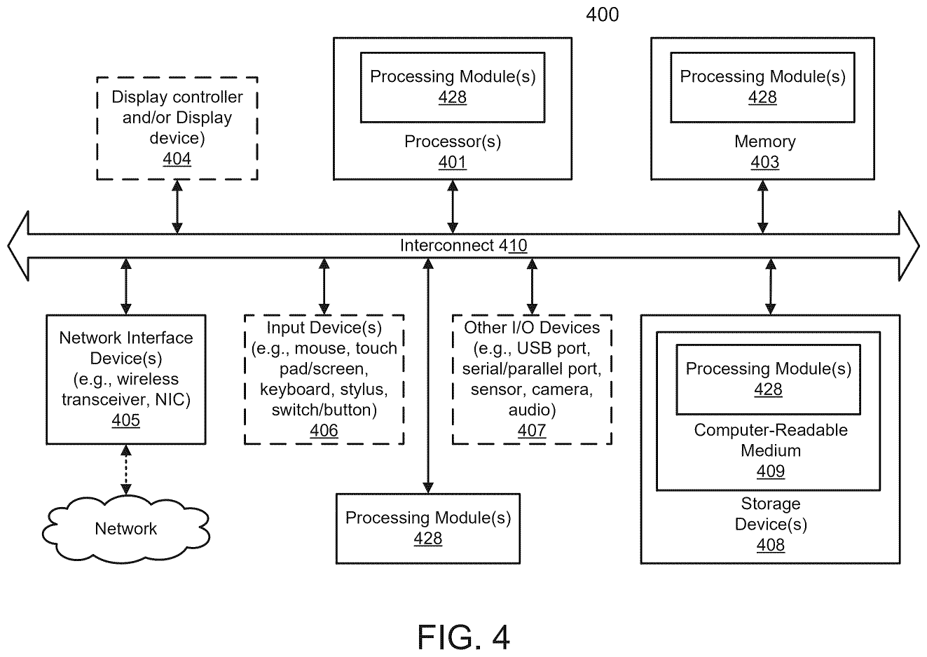

Any of data sources 100, downstream consumers 102, and inference model manager 104 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., smartphone), an embedded system, local controllers, an edge node, and/or any other type of data processing device or system. For additional details regarding computing devices, refer to the discussion of FIG. 4.

Any of the components illustrated in FIG. 1 may be operably connected to each other (and/or components not illustrated) with communication system 106. Communication system 106 may facilitate communications between the components of FIG. 1. In an embodiment, communication system 106 includes one or more networks that facilitate communication between any number of components. The networks may include wired networks and/or wireless networks (e.g., and/or the Internet). The networks and communication devices may operate in accordance with any number and types of communication protocols (e.g., such as the Internet protocol).

While illustrated in FIG. 1 as including a limited number of specific components, a system in accordance with an embodiment may include fewer, additional, and/or different components than those illustrated therein.

To further clarify embodiments disclosed herein, data flow diagrams in accordance with an embodiment are shown in FIGS. 2A-2C. In the diagram, flows of data and processing of data are illustrated using different sets of shapes. A first set of shapes (e.g., 200, 201) is used to represent data structures, a second set of shapes (e.g., 202, 212) is used to represent processes performed using and/or that generate data, and a third set of shapes (e.g., 100C) is used to represent sources of data.

Turning to FIG. 2A, a first data flow diagram in accordance with an embodiment is shown. The first data flow diagram may illustrate data used in and data processing performed when facilitating operation of an inference model. For example, the inference model may be used to manage operation of a data processing system.

In the example shown in FIG. 2A, operation of the inference model may include a training process and an inferencing process. The training process may include, for example, initial training of an (untrained) inference model, retraining of an inference model, and/or fine-tuning of an inference model. The inferencing process may include, for example, obtaining inferences using a trained inference model.

To obtain a trained inference model, a management entity (e.g., inference model manager 104) may facilitate performance of training process 202. Training process 202 may include training an untrained inference model defined by untrained model data 200.

Untrained model data 200 may include information relating to model architecture, hyperparameters, and/or other information regarding an untrained inference model (e.g., optimization algorithm information, hidden layer information, bias function descriptions, activation function descriptions, etc.). An inference model type and/or size may be selected based on performance goals and/or constraints, training data availability and/or quality, budget, timeline, etc. For example, the inference model may include a probabilistic model such as a generative machine-learning model (e.g., a large language model).

During training process 202, untrained model data 200 may be updated using training data 201. Training data 201 may be obtained from any number of data sources (e.g., training data sources 100A). For example, if the inference model is being trained to manage security for a data processing system, then the training data may include a corpus of information regarding types of security threats to the data processing system, labeled with actions for responding to the types of security threats (e.g., actions for reconfiguring security settings of the data processing system accordingly). As the inference model is exposed to large numbers of relationships and/or patterns in training data 201, weights and/or other parameters of untrained model data 200 may be modified to obtain trained model data 204.

Trained model data 204 may include inference model data (e.g., information regarding the architecture and/or hyperparameters of the inference model) and/or model parameter values of the inference model (e.g., weights). Trained model data 204 may be used during an inferencing process to generate inferences in response to ingest data, such as ingest data 210.

Ingest data 210 may include a portion of data for which an inference is desired to be obtained. For example, ingest data 210 may include prompt 206 (e.g., of prompts 100B). Prompt 206 may be obtained, for example, from a consumer of inferences and may include instances of ontology terms. To obtain ingest data 210 (e.g., an enhanced version of prompt 206), prompt 206 may undergo prompt preprocessing 208. For example, during prompt preprocessing 208, context data for ontology terms present in prompt 206 may be obtained, and ingest data 210 may be generated based on prompt 206 and/or the context data. Refer to the discussion of FIG. 2B for more details regarding prompt preprocessing and/or obtaining ingest data 210.

Ingest data 210, along with trained model data 204, may be provided to inferencing process 212. During inferencing process 212, a trained inference model may be obtained based on information (e.g., node information, weight information, connection information, activation functions, attention mechanisms, etc.) included in trained model data 204. Ingest data 210 may not include labeled data and, thus, an association for ingest data 210 may not be known. During inferencing process 212, the trained inference model (e.g., a trained generative machine-learning model) may read ingest data 210 and respond with an output likely to be associated with the input (e.g., the trained inference model may generate an inference).

For example, ingest data 210 may include information regarding malicious code being executed by a component of a data processing system, and inference 214 may include actions for updating security settings of the data processing system that are likely to mitigate an outcome of the execution of the malicious code according to relationships and/or patterns learned by the inference model during training process 202. Inference 214 may be used to provision computer-implemented services. For example, inference 214 may be provided to downstream process 216, and downstream process 216 may include delivery of inference 214 to a downstream consumer (e.g., as a computer-implemented service), and/or further processing of inference 214.

For example, downstream process 216 may include any type of process for updating operation of the data processing system based on inference 214. For example, downstream process 216 may include a policy enforcement process, wherein security policies for the data processing system are enforced based on information included in inference 214 (e.g., actions, security and/or configuration settings) in order to mitigate outcomes associated with the execution of the malicious code. For example, operation of the data processing system may be updated to prevent access to sensitive data, to prevent network communication via components of the data processing system, and/or to disable operation of portions of components of the data processing system.

Although described with respect to security of the data processing system, it will be appreciated that the inference models may be trained and used to update operation of the data processing system in various capacities without departing from the embodiments disclosed herein. For example, the operation of the data processing system may be updated to improve user experience, to manage failures of components of the data processing system, to improve efficient allocation of resources (e.g., computing and/or power resources), and/or to meet other operational goals for the data processing system.

Thus, using the data flows shown in FIG. 2A, operation of a data processing system may be managed based on inferences generated by trained inference models. By doing so, operation of the data processing systems may be updated timely, and the data processing systems may be more likely to operate in a desired manner.

However, a quality (e.g., usability, reliability) of the inferences generated by the trained inference models may depend on a quality of ingest data to the trained inference models. Therefore, to increase a likelihood of the ingest data being of expected quality (e.g., having adequate informational content), ontology terms included in prompts for the trained inference models may be contextualized. Methods for obtaining context data for the prompts may be discussed with respect to FIG. 2B.

Turning to FIG. 2B, a second data flow diagram in accordance with an embodiment is shown. The second data flow diagram may illustrate data used in and data processing performed when obtaining ingest data for an inference model. FIG. 2B may be an example of prompt preprocessing 208 of FIG. 2A.

To obtain the ingest data, context data for prompt 206 may be retrieved from knowledge data sources 100C. Prompt 206 may include a submission to be processed by a trained inference model to facilitate provisioning of desired computer-implemented services by a data processing system. For example, prompt 206 may include information regarding operation of the data processing system.

To obtain the context data for prompt 206, retrieval process 220 may be performed. Retrieval process 220 may include any type of process(es) wherein information (e.g., terms) present in a prompt is identified, and additional information is retrieved from a data source based on the identified information. For example, retrieval process 220 may implement information retrieval methods used during type of retrieval-augmented generation process. During retrieval process 220, a prompt (e.g., prompt 206) may be obtained and used to generate a query (e.g., a keyword search query). The query may include, for example, search terms, search parameters, and/or other information. The query may then be used to search an external data source such as knowledge data sources 100C to identify responsive portions of data stored by the external data source.

As discussed with respect to FIG. 1, knowledge data sources 100C may include a data source designated as a source of true (e.g., trusted, reliable, relevant to a subject area) data by an operator of the inference model. For example, knowledge data sources 100C may include a number of chunks of data that are tagged to associate each of the number of chunks of data with ontology terms (and/or other searchable terms).

During a first performance of retrieval process 220, an original query may be generated based on prompt 206 (e.g., during the first performance of retrieval process 220, ontology terms may not be obtained from context data analysis process 222 as indicated by a respective arrow drawn in dashing). The original query may be derived from terms (e.g., words and/or phrases) present in prompt 206. The original query may be serviced using a deterministic process (e.g., using a trained deterministic inference model and/or any process that returns the same results for repeated servicing of the original query). For example, the original query may be used to identify portions of data responsive to the search terms and using the search parameters and/or instructions included in the original query from knowledge data sources 100C.

The identified portions of data responsive to the original query may then be ranked for relevance using a relevance ranking algorithm. Some number (e.g., best hits) of the ranked portions of data may then be selected for use as the context data. However, due to limitations of the relevance ranking algorithm and/or selection criteria, the selected context data may lack context for some terms present in the prompt such as those defined by ontology definitions 224. Therefore, to address these limitations of retrieval process 220, context data analysis process 222 may be performed.

Context data chunks 228 may be obtained from retrieval process 220 and may include the context data. The context data may include (i) system logs (e.g., at least one record of an event and/or an activity within a data processing system, etc.), (ii) performance metrics (e.g., memory consumption, at least one input/output operation, network traffic, etc.), (iii) system health checks (e.g., at least one report of a status of the data processing system, etc.), etc.

Context data chunks 228 may include the context data in a form of at least one data chunk.

The at least one data chunk may include a discrete and/or segmented portion of the context data (e.g., a key and/or value pair from a system log and/or a report of the performance metrics, a status message from a system health check, etc.). The at least one data chunk of context data chunks 228 may include a first ranking based on any magnitude of relevancy of the at least one data chunk to prompt 206.

Context data chunks 228 may be ingested by data chunk adaptation process 230. During data chunk adaptation process 230, information elimination may be performed on context data chunks 228. The information elimination may be performed by eliminating duplicative context data and/or conflicting context data from the set of the chunks. To eliminate the duplicative context data and/or conflicting context data, the at least one data chunk of the set of chunks may be compared to a second at least one data chunk. If the duplicative context data and/or the conflicting context data is found between the at least one data chunk and/or the second at least one data chunk, the duplicative context data and/or the conflicting context data in the at least one data chunk and/or the second at least one data chunk may be removed. A description of FIG. 2C below further describes data chunk adaptation process 230.

As a result of the information elimination, context data original chunks 232 and/or context data pseudo chunks 234 may be generated. Context data pseudo chunks 234 may include a first portion of context data chunks 228, the first portion from which the duplicative context data and/or the conflicting context data has been eliminated. Further, context data pseudo chunks 234 may include a third at least one data chunk that therefore may be in an edited format compared to a fourth at least one data chunk that includes the duplicative context data and/or the conflicting context data extracted from the trusted knowledge base (e.g., knowledge data sources 100C). Context data original chunks 232 may include a second portion of context data chunks 228 in which the duplicative context data and/or conflicting context data was not present.

Because of the performance of the information elimination during data chunk adaptation process 230, any magnitude of relevancy between context data original chunks 232 and/or context data pseudo chunks 234 to prompt 206 may change. Therefore, during data chunk adaptation process 230, context data chunks rankings 236 may be generated. Context data chunks rankings 236 may include a second ranking based on any new magnitude of relevancy of the at least one data chunk included in context data original chunks 232 and/or context data pseudo chunks 234 to prompt 206.

During context data analysis process 222, the context data (e.g., context data original chunks 232, context data pseudo chunks 234, and context data chunks rankings 236) obtained from retrieval process 220 may be analyzed using ontology definitions 224. Ontology definitions 224 may include, for example, a list (e.g., a table) of ontology terms. As discussed with respect to FIG. 1, the ontology terms may include words and/or phrases that have been designated as having a higher degree of meaning by an operator of the inference model than other words and/or phrases not designated as having the higher degree of meaning by the operator. For example, the ontology terms may include words and/or phrases that have different definitions in different subject areas.

During context data analysis process 222, first context data (e.g., context data original chunks 232, context data pseudo chunks 234, and context data chunks rankings 236) obtained from the first retrieval process may be evaluated to determine whether the first context data meets sufficiency criteria. The sufficiency criteria may specify a minimum level of content of context data with respect to ontology definitions 224. For example, instances of ontology terms specified by ontology definitions 224 that are present in prompt 206 may be identified, and levels of content of the first context related to each instance of the ontology terms may be identified. The levels of content may be compared to the minimum level of content to identify any instances of ontology terms for which the first context data does not meet the sufficiency criteria.

For example, the minimum level of content may specify, for each ontology term of ontology definitions 224 present in prompt 206, (i) a minimum number of words related to the respective ontology terms, (ii) a minimum number of chunks of data in the first context data that are tagged as related to the respective ontology terms, and/or (iii) a combination thereof.

The sufficiency criteria for the context data may be defined by policies. For example, the policies may specify a reduced number of ontology terms present in prompt 206 that are required to satisfy the minimum level of content, and/or an increased number of terms (e.g., other ontology terms defined by ontology definitions 224, other terms not defined by ontology definitions 224) beyond the ontology terms present in prompt 206 that are required to satisfy the minimum level of content. Any instances of ontology terms identified as present in prompt 206 that are not associated with context data satisfying at least the minimum level of content may be identified during context data analysis process 222.

If the first context data meets the sufficiency criteria for all ontology terms present in prompt 206, then the first context data may be included in all context data 226. However, if at least one instance of an ontology term may be identified for which the first context data does not meet the sufficiency criteria, then at least a portion of the first context data may be included in all context data 226 (e.g., the portion of the first context data that meet the sufficiency criteria).

In a first example, the at least one instance of the ontology term (e.g., shown as “ontology terms” in FIG. 2B) having insufficient context data may be provided to retrieval process 220 to initiate a second (iteration of) retrieval process 220 (e.g., ontology terms for which sufficient context data has been retrieved may not be included in the ontology terms provided to retrieval process 220.

In a second example, the ontology terms provided to retrieval process 220 may include all ontology terms identified in prompt 206, and each of the ontology terms may be tagged (e.g., via updating metadata) to indicate whether sufficient context data has been retrieved for each of the ontology terms. For example, the ontology term associated with the identified at least one instance may be tagged as being associated with insufficient context data, while other ontology terms may be tagged as being associated with sufficient context data.

Note that the arrow indicating the ontology terms are provided to retrieval process 220 is drawn in dashing to indicate that under some conditions the ontology terms may not be provided to retrieval process 220 (e.g., during a first iteration of retrieval process 220 and/or during subsequent iterations of retrieval process 220 when retrieved context data meets the sufficiency criteria for all ontology terms present in prompt 206).

During the second retrieval process, a revised query may be derived using the ontology terms obtained from context data analysis process 222. For example, the revised query may only include ontology terms that are tagged as associated with insufficient context data. The revised query may include a reduced number of ontology terms specified by the ontology definitions when compared to a number of ontology terms specified by the original query. The reduced number of ontology terms may include the ontology term (e.g., for which the at least one instance of the ontology term was identified), and may exclude a second ontology term of ontology definitions 224 for which an instance of the second ontology term is present in prompt 206 and for which the first context data meets the sufficiency criteria (e.g., the second ontology term having been included in the original query).

Consider a security example where a prompt, “Program A is being executed by component C of data processing system D, using resources Q, and is accessing file F”, is provided to retrieval process 220. During the first retrieval process, “A”, “C”, “D”, and “F” may include ontology terms specified by ontology definitions 224. The ontology terms may be identified and used to obtain the original query. Therefore, the original query may include 4 ontology terms specified by ontology definitions 224.

During the first retrieval process, knowledge data sources 100C may return sufficient context data for “A” “C”, and “D”, but not “F”. Therefore, during context data analysis process 222, “F” may be identified as not being associated with at least the minimum level of content specified by the sufficiency criteria. Therefore, context data analysis process 222 may provide a data package including “F” (and excluding “A”, “C”, and “D”, for which sufficient context data has already been obtained) to retrieval process 220, and a second retrieval process may be performed. The second retrieval process may use a revised query that includes 1 ontology term specified by ontology definitions 224 (e.g., “F”).

Returning to the second retrieval process, the revised query may be used to retrieve second context data from knowledge data sources 100C. By using the revised query, the search algorithm used during retrieval process 220 may be more likely to rank and select sufficient context data for the ontology terms included in the revised query compared to when using the original query.

The second context data, which is included in context data original chunks 232, context data pseudo chunks 234, and/or context data chunks rankings 236 after data chunk adaptation process 230 has been performed, may be provided to context data analysis process 222, and a determination may be made regarding whether the second context data meets the sufficiency criteria. If the second context data meets the sufficiency criteria, then the second context data may be included in all context data 226. However, if the second context data does not meet the sufficiency criteria, then at least a portion of the second context data may be included in all context data 226, and context data analysis process 222 may be performed to identify ontology terms for which the second context data is insufficient. Iterations of retrieval process 220 and/or context data analysis process 222 may be performed until all context data 226 meets the sufficiency criteria for each instance of ontology terms present in prompt 206.

All context data 226 may include context data retrieved during any number of iterations of retrieval process 220. All context data 226 may be used, in part, to obtain ingest data 210. For example, ingest data 210 may include all context data 226 (e.g., the first context data and/or the second context data) and/or prompt 206. Ingest data 210 may be provided to an inferencing process so that a response (e.g., an inference) may be obtained using a trained inference model. For example, ingest data 210 may be provided to inferencing process 212 of FIG. 2A.

Returning to the security example, the response obtained from the inference model (e.g., inference 214 in FIG. 2A) during the inferencing process may indicate that program A is likely to include malicious code, and that file F is not expected to be accessed by program A during desired operation of data processing system D. The response may indicate that a security policy for data processing system D should be enforced (e.g., which may occur during downstream process 216 of FIG. 2A).

Turning to FIG. 2C, a third data flow diagram in accordance with an embodiment is shown. The third data flow diagram may illustrate data used in and data processing performed in performing data chunk adaptation process 230 (from FIG. 2B).

To perform data chunk adaptation process 230 (from FIG. 2B), information elimination process 238 may be performed first. During information elimination process 238, context data chunks 228 may be ingested.

Context data chunks 228 may be obtained from retrieval process 220 (from FIG. 2B) and may include context data. The context data may include (i) system logs (e.g., at least one record of an event and/or an activity within a data processing system, etc.), (ii) performance metrics (e.g., memory consumption, at least one input/output operation, network traffic, etc.), (iii) system health checks (e.g., at least one report of a status of the data processing system, etc.), etc. Context data chunks 228 may include the context data in a form of at least one data chunk. The at least one data chunk may include a discrete and/or segmented portion of the context data (e.g., a key and/or value pair from a system log and/or a report of the performance metrics, a status message from a system health check, etc.). The at least one data chunk of context data chunks 228 may include a first ranking based on any magnitude of relevancy of the at least one data chunk to prompt 206 (from FIG. 2B).

During information elimination process 238, duplicative context data and/or conflicting context data may be eliminated from context data chunks 228. To eliminate the duplicative context data and/or the conflicting context data, the at least one data chunk of the set of chunks may be compared to a second at least one data chunk. If the duplicative context data and/or the conflicting context data is found between the at least one data chunk and the second at least one data chunk, the duplicative context data and/or the conflicting context data in the at least one data chunk and/or the second at least one data chunk may be eliminated.

Methods by which the duplicative context data and/or the conflicting context data can be found may include (i) keyword searching (e.g., searching for at least key and/or value pairs with non-matching values), (ii) exact match searching (e.g., searching for at least one portion of warnings, status messages, etc. to perform at least one comparisons), (iii) data normalization (e.g., converting data into at least one standard format to enable performance of the at least one comparison), (iv) data validation (e.g., ensuring that the data conforms to at least one pre-defined schema, with which to identify invalid and/or inconsistent entries), (v) information deduplication (e.g., generating, using a large language model, first text using information from a second text), etc.

If the duplicative context data has been found between the at least one data chunk and/or the second at least one data chunk, the duplicative context data may be eliminated, using, for example, the large language model, from either the at least one data chunk or the second at least one data chunk. The first ranking may be used to prioritize removal of the duplicative context data from either the at least one data chunk or the second at least one data chunk, whichever has a lower ranking of the first ranking.

If the conflicting context data has been found between the at least one data chunk and/or the second at least one data chunk, the conflicting context data may be eliminated, using, for example, the large language model, from either the at least one data chunk and/or the second at least one data chunk. The conflicting context data may be found by, for example, (i) a first comparison between the at least two key and/or value pairs, (ii) a second comparison between at least two warnings, status messages, etc., (iii) a third comparison between normalized data, etc. Once the conflicting context data has been found, a determination may be made which key and/or value pairs, warnings, status messages, normalized data, etc. includes incorrect data of the conflicting context data. The determination may be made (i) generating, using at least the conflicting context data, a first inference from inference model (e.g., large language models, small language models, retrieval augmented generators, etc.), (ii) comparing the conflicting context data to at least one definition of ontology terms (e.g., words and/or phrases defined by an administrator, trusted knowledge base, etc. of the data processing system, etc.), etc. Once the determination has been made, the conflicting context data may be eliminated from either the at least one data chunk and/or the second at least one data chunk.

As a result of removing the duplicative context data and/or the conflicting context data from context data chunks 228, context data original chunks and/or context data pseudo chunks may be generated. The context data pseudo chunks may include a first portion of context data chunks, the first portion from which the duplicative context data and/or the conflicting context data has been eliminated. Further, the context data pseudo chunks may include a third at least one data chunk that may be therefore in an edited format compared to a fourth at least one data chunk that includes the duplicative context data and/or the conflicting context data extracted from the trusted knowledge base (e.g., knowledge data sources 100C). The context data original chunks may include a second portion of context data chunks 228 in which the duplicative context data and/or conflicting context data is not present.

Because of the elimination of the duplicative context data and/or the conflicting context data, any magnitude of relevancy between context data original chunks 232, the context data pseudo chunks, and/or the context data original chunks to prompt 206 (from FIG. 2B) may change. Therefore, during information elimination process 238, context data chunks ranking may be generated. Context data chunks ranking may include a second ranking based on any new magnitude of relevancy of the at least one data chunk included in the context data original chunks and/or the context data pseudo chunks to prompt 206 (from FIG. 2B).

The context data chunks rankings may be generated, using the context data original chunks and/or the context data pseudo chunks, by using (i) keyword matching, (ii) term frequency methods, (iii) natural language processing, etc. For example, a first term may be found that appears frequently in the context data original chunks and/or the context data pseudo chunks. Thus, any data chunks of the context data original chunks and/or the context data pseudo chunks that includes more information about the first term may be assigned a higher ranking than other data chunks. In a second example, natural language processing may be used to ingest at least the context data original chunks, the context data pseudo chunks and/or prompt 206 and/or to generate the context data chunks ranking based on the any magnitude of the relevance.

The context data chunks rankings, the context data original chunks and/or the context data pseudo chunks may be further ingested in elimination validation process 240. During elimination validation process 240, the context data chunks ranking, the context data original chunks and/or the context data pseudo chunks may be validated. The validation may be performed by ensuring that at least one criterium has been met. The at least one criterium may include (i) a minimum number of iterations during information elimination process 238 has been performed, (ii) a threshold score has been met and/or exceeded by (a) the keyword matching, (b) the term frequency methods, (c) the natural language processing, etc. that is set by (a) an administrator, (b) an operator, etc. of the data processing system, etc.

If the at least one criterium has been met, then, (i) context data original chunks 232 may be output as the context data original chunks, (ii) context data pseudo chunks 234 may be output as the context data pseudo chunks, and/or (iii) context data chunks rankings 236 may be output as the context data chunks rankings. Otherwise, if the at least one criterium has not been met, then the context data chunks rankings, the context data original chunks and/or the context data pseudo chunks may be ingested by elimination validation process 240 to generate second context data chunks rankings, second context data original chunks and/or second context data pseudo chunks.

Information elimination process 238 and/or elimination validation process 240 may be repeated until context data original chunks 232, context data pseudo chunks 234, and/or context data chunks rankings 236 are output.

Thus, via the third data flow diagram illustrated in FIG. 2C, a system in accordance with an embodiment may perform data chunk adaptation process 230 (from FIG. 2B). Consequently, a deployment may be more likely to be able to provide desired computer implemented services by generating ranked context data that does not include the duplicative context data and/or the conflicting context data.

Any of the processes illustrated using the second set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIG. 1 may perform various methods to managing operation of a deployment. FIG. 3 illustrates a method that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method of managing the operation of the deployment in accordance with an embodiment is shown. The method may be performed, for example, by any of the components of the system of FIG. 1, and/or other components not shown therein.

At operation 300, a set of chunks and a rank ordering for the set of the chunks may be obtained, based on a prompt for processing by a trained generative machine-learning model, from a knowledge data source. The set of chunks and the rank ordering for the set of the chunks may be obtained by (i) performing, by a retrieval augmented system, a search in a database of stored context data, (ii) identifying at least one data chunk of context data of the set of the chunks, and/or (iii) ranking the at least one data chunk based on any magnitude of relevancy of the at least one data chunk to a prompt, on which the search is based, to generate the rank ordering of the at least one ranked data chunk of the set of the chunks.

At operation 302, the information elimination may be performed on the set of the chunks to obtain (i) a portion of the set of chunks, (ii) a set of pseudo chunks based on a second portion of the set of chunks, and/or (iii) a second rank ordering that defines ordering among the portion of the set of chunks and the set of pseudo chunks. The information elimination may be performed by removing duplicative context data and/or conflicting context data from the at least one data of the set of the chunks to generate the set of the pseudo chunks based on the second portion of the set of the chunks. The portion of the set of the chunks may be obtained from the set of the chunks that did not include the duplicative context data and/or the conflicting context data. Further, the second rank ordering may be performed by identifying any magnitude of relevancy of the set of the pseudo chunks and/or the portion of the set of the chunks with the prompt.

At operation 304, a response to the prompt may be obtained using at least the portion of the set of chunks, the set of pseudo chunks, the second rank ordering, and/or a trained generative machine-learning model. The response may be obtained by ingesting, by the trained generative machine-learning model, (i) the set of the pseudo chunks, (ii) the portion of the set of the chunks, and/or (iii) the second rank ordering. Upon the ingestion, the trained generative machine-learning model may generate the response that indicates (i) a root cause of the behavior, (ii) a remediation process to address the behavior, (iii) a diagnosis process for the behavior, etc.

At operation 306, computer implemented services may be provided using the response. The computer implemented services may be provided by (i) using the root cause in the response to identify at least one issue related to the behavior in the data processing system, (ii) performing, by the data processing system, the remediation process to address the behavior of the data processing system, (iii) performing, by the data processing system, the diagnosis process to troubleshoot the behavior of the data processing system, etc.

The method may end following operation 306.

Thus, via the method shown in FIG. 3, embodiments herein may improve a likelihood of managing the operation of the deployment. By improving the likelihood of managing the operation of the deployment, the deployment may be more likely to provide desirable computer implemented services by, for example, refining a quality of context data obtained from a retrieval augmented system to generate optimized context data, improving, using the optimized context data, the response that is generated by the trained generative machine-learning model, etc.

Any of the components illustrated in FIGS. 1-2C may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device.

For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both.

Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

1. A method for managing operation of a deployment, the method comprising:
retrieving, based on a prompt for processing by a trained generative machine-learning model, a set of chunks and a rank ordering for the set of the chunks from a knowledge data source;
performing, after retrieving the set of chunks and the rank ordering for the set of chunks from the knowledge data source, an information elimination process on the set of the chunks to obtain:
a portion of the set of chunks,
a set of pseudo chunks based on a second portion of the set of the chunks, and
a second rank ordering that defines ordering among the portion of the set of the chunks and the set of the pseudo chunks;
obtaining a response to the prompt using at least the portion of the set of the chunks, the set of the pseudo chunks, the second rank ordering, and the trained generative machine-learning model; and
providing computer implemented services using the response.

2. The method of claim 1, wherein, during the information elimination process, portions of each of the second portion of the set of chunks are eliminated to obtain the set of the pseudo chunks.

3. The method of claim 2, wherein the portions of each of the second portion of the set of chunks comprise duplicative or contradictory information with respect to at least one of the portions of the set of chunks.

4. The method of claim 3, wherein the second rank ordering is obtained using a same process through which the rank ordering is obtained, and the second rank ordering takes into account eliminated portions of each of the second portion of the set of chunks.

5. The method of claim 4, wherein elimination of the portions of each of the second portion of the set of chunks changes relevancies of the second portion of the set of chunks with respect to the prompt.

6. The method of claim 4, wherein the rank ordering and the second rank ordering indicate relevancy with respect to the prompt.

7. The method of claim 1, wherein the prompt is based on a behavior of a data processing system, and the response indicates at least one selected from a group consisting of:
a root cause for the behavior;
a remediation process to be performed to address the behavior; and
a diagnosis process for the behavior.

8. The method of claim 1, wherein the knowledge data source comprises a plurality of chunks, and the set of chunks is a sub-set of the plurality of chunks that are evaluated as being relevant to the prompt.

9. The method of claim 8, wherein at least two of the plurality of chunks comprise contradictory information regarding a portion of the prompt.

10. The method of claim 8, wherein at least two of the plurality of chunks comprise duplicative information regarding a portion of the prompt.

11. A non-transitory machine-readable medium having instructions stored therein, which when executed by a processor, cause the processor to perform operations for managing operation of a deployment, the operations comprising:
retrieving, based on a prompt for processing by a trained generative machine-learning model, a set of chunks and a rank ordering for the set of the chunks from a knowledge data source;
performing, after retrieving the set of chunks and the rank ordering for the set of chunks from the knowledge data source, an information elimination process on the set of the chunks to obtain:
a portion of the set of chunks,
a set of pseudo chunks based on a second portion of the set of the chunks, and
a second rank ordering that defines ordering among the portion of the set of the chunks and the set of the pseudo chunks;
obtaining a response to the prompt using at least the portion of the set of the chunks, the set of the pseudo chunks, the second rank ordering, and the trained generative machine-learning model; and providing computer implemented services using the response.

12. The non-transitory machine-readable medium of claim 11, wherein, during the information elimination process, portions of each of the second portion of the set of chunks are removed to obtain the set of the pseudo chunks.

13. The non-transitory machine-readable medium of claim 12, wherein the portions of each of the second portion of the set of chunks comprise duplicative or contradictory information with respect to at least one of the portion of the set of chunks.

14. The non-transitory machine-readable medium of claim 13, wherein the second rank ordering is obtained using a same process through which the rank ordering is obtained, and the second rank ordering takes into account eliminated portions of each of the second portion of the set of chunks.

15. The non-transitory machine-readable medium of claim 14, wherein elimination of the portions of each of the second portion of the set of chunks changes relevancies of the second portion of the set of chunks with respect to the prompt.

16. A data processing system, comprising:
a processor; and
a memory coupled to the processor to store instructions, which when executed by the processor, cause the processor to perform operations managing operation of a deployment, the operations comprising:
retrieving, based on a prompt for processing by a trained generative machine-learning model, a set of chunks and a rank ordering for the set of the chunks from a knowledge data source;
performing, after retrieving the set of chunks and the rank ordering for the set of chunks from the knowledge data source, an information elimination process on the set of the chunks to obtain:
a portion of the set of chunks,
a set of pseudo chunks based on a second portion of the set of the chunks, and
a second rank ordering that defines ordering among the portion of the set of the chunks and the set of the pseudo chunks;
obtaining a response to the prompt using at least the portion of the set of the chunks, the set of the pseudo chunks, the second rank ordering, and the trained generative machine-learning model; and
providing computer implemented services using the response.

17. The data processing system of claim 16, wherein, during the information elimination process, portions of each of the second portion of the set of chunks are removed to obtain the set of the pseudo chunks.

18. The data processing system of claim 17, wherein the portions of each of the second portion of the set of chunks comprise duplicative or contradictory information with respect to at least one of the portion of the set of chunks.

19. The data processing system of claim 18, wherein the second rank ordering is obtained using a same process through which the rank ordering is obtained, and the second rank ordering takes into account eliminated portions of each of the second portion of the set of chunks.

20. (canceled)

21. The method of claim 1, further comprising:
after the information elimination process and before obtaining the response to the prompt:
performing an elimination validation process on all of the portion of the set of the chunks, the set of the pseudo chunks, and the second rank ordering to validate obtained using the information elimination process to obtain a validated instance of all of the portion of the set of the chunks, the set of the pseudo chunks, and the second rank ordering, where the elimination validation process is performed to validate that at least one preset criterium set for the information elimination process is met, and
wherein the validated instance of the all of the portion of the set of the chunks, the set of the pseudo chunks, and the second rank ordering are used along with the trained generative machine-learning model to obtain the response to the prompt.
